(19) United States
(12) Patent Application Publication
(10) Pub. No.: US 2011/0231165 A1
(43) Pub. Date: Sep. 22, 2011

(54) CIRCUIT SIMULATOR AND METHOD OF DESIGNING SEMICONDUCTOR DEVICE

(75) Inventor: Kouichirou Inoue, Yokosuka-shi (JP)

(73) Assignee: KABUSHIKI KAISHA TOSHIBA, Tokyo (JP)

(21) Appl. No.: 12/882,916

(22) Filed: Sep. 15, 2010

(30) Foreign Application Priority Data
Mar. 18, 2010 (JP) 2010-063021

(51) Int. Cl. G06F 17/50; G06F 17/10; G06F 17/11

(52) U.S. Cl. 703/2; 716/136; 703/14

(57) ABSTRACT

According to the embodiments, an impact ionization current is calculated based on a drain transverse electric field calculation formula in which a saturated source-drain voltage is given by a function of a source-gate voltage and a source-drain voltage.

### CROSS-REFERENCE TO RELATED APPLICATIONS

This application is based upon and claims the benefit of priority from the prior Japanese Patent Application No. 2010-63021, filed on Mar. 18, 2010; the entire contents of which are incorporated herein by reference.

### FIELD

The present embodiments typically relate to a circuit simulator and a method of designing a semiconductor device.

### BACKGROUND

In recent years, with the miniaturization of transistors constituting semiconductor integrated circuits, degradation of driving force of the transistors due to hot carrier is significantly increasing. Therefore, in designing of the integrated circuits, designing with the degradation due to the hot carrier taken into account is indispensable. It has been known that a component of a transistor substrate current generated due to impact ionization (hereinafter, referred to as an impact ionization current) is appropriate for use as an index of the amount of degradation due to the hot carrier.

In generally-known hot carrier degradation models, a consistent relationship exists between the amount of degradation that occurs in driving-related characteristics such as a drain current due to the hot carrier and the impact ionization current, so that the amount of degradation due to the hot carrier can be calculated depending on increase or decrease in the impact ionization current. Therefore, in order to accurately estimate the degradation of driving characteristics of the transistor during operation of the integrated circuit, it is necessary to accurately calculate the impact ionization current in accordance with circuit operation in circuit simulation. The calculation formula of the impact ionization current has been formulated as represented by the following Equation (1), which is built in transistor models such as BSIM (Berkeley Short-channel IGFET Model), or the like.

$$Iii = α {E}_{d} exp ( - \frac{β}{{E}_{d}} ) Ids \\ {E}_{d} = \frac{{V}_{ds} - {V}_{dsat}}{λ} \qquad ( 1 )$$

where,
Iii: impact ionization current,
E_{d}: drain transverse electric field,
V_{ds}: source-drain voltage,
V_{dsat}: saturated source-drain voltage,
Ids: drain current,
α, β: constant coefficient, and
λ: characteristic length of drain transverse electric field.

As can be seen from Equation (1), the impact ionization current Iii has a tendency to increase and then decrease with increase in a source-gate voltage V_{gs}. However, with this initial formulation, it has been known that when the gate length is reduced, the impact ionization current Iii gradually declines with respect to measured values in the region where the source-gate voltage V_{gs} is relatively high.

This is because as the gate length of the transistor is reduced, the transverse electric field near a drain in a state where the source-drain voltage V_{ds} is being applied becomes less likely to decrease even if the source-gate electrode V_{gs} is increased. Several modified models for correcting the above problems have been proposed. These models are aimed at improving fitting accuracy by, for example, changing the characteristic length λ of the drain transverse electric field from a constant to a function of the source-gate voltage V_{gs} or the source-drain voltage V_{ds} (see Japanese Patent Application Laid-open No. 2005-259778) or by adding a factor to multiply a saturated drain voltage by a constant number as employed in transistor models such as PSP (Pennsylvania State University-Philips) and HiSIM (Hiroshima-university STARC IGFET Model).

### BRIEF DESCRIPTION OF THE DRAWINGS

FIG. 1 is a block diagram illustrating a general configuration of a circuit simulator according to a first embodiment;

FIG. 2 is a diagram illustrating a method of adjusting fitting parameters of a function used for calculating an impact ionization current according to a second embodiment;

FIG. 3 is a diagram illustrating a relationship between an impact ionization current Iii, which is calculated by the circuit simulator shown in FIG. 1 by using a source-drain voltage V_{ds} as a parameter, and a source-gate voltage V_{gs}, with comparison to measured values;

FIG. 4 is a flowchart for explaining a circuit design method according to a third embodiment; and

FIG. 5A is a diagram illustrating an example of design layout data; FIG. 5B is a block diagram illustrating a general configuration of a circuit simulator according to a fourth embodiment; FIGS. 5C-5F are diagrams explaining a method of manufacturing a semiconductor device according to a fifth embodiment.

### DETAILED DESCRIPTION

In general, according to one embodiment, an impact ionization current of a field-effect transistor is calculated based on a calculation formula for a drain transverse electric field. In the calculation formula, a saturated source-drain voltage is given by a function of a source-gate voltage and a source-drain voltage.

Exemplary embodiments of a circuit simulator and a method of designing a semiconductor device according to the present invention will be explained in detail below with reference to the accompanying drawings.

### First Embodiment

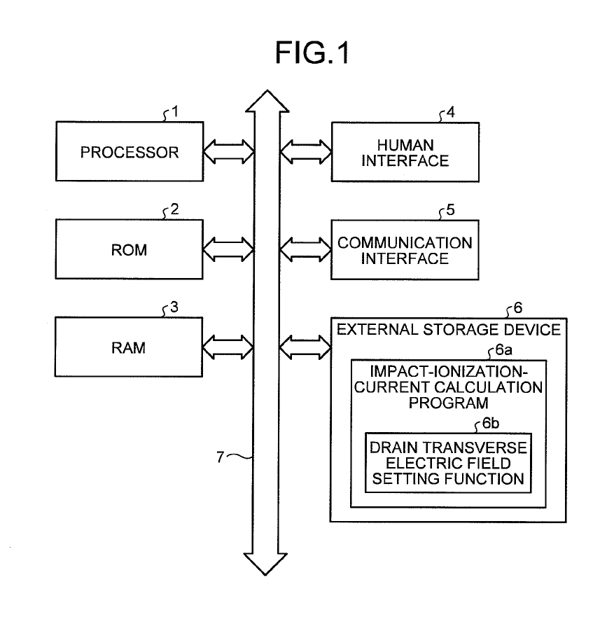

FIG. 1 is a block diagram illustrating a general configuration of a circuit simulator according to a first embodiment. The present invention is not limited by the following embodiments.

In FIG. 1, the circuit simulator includes a processor 1 including a CPU or the like, a ROM 2 for storing fixed data, a RAM 3 that functions as a work area or the like for use by the processor 1, a human interface 4 that functions as intermediary between persons and a computer, a communication interface 5 that functions as a means for communicating with external devices, and an external storage device 6 for storing computer programs and various types of data for operating the processor 1. The processor 1, the ROM 2, the RAM 3, the human interface 4, the communication interface 5, and the external storage device 6 are connected to one another via a bus 7.

As the external storage device 6, a magnetic disk such as a hard disk, an optical disk such as a DVD, a portable semiconductor storage device such as a USB memory or a memory card, or the like may be used. As the human interface 4, a keyboard, a mouse, or the like may be used as an input interface, and a display, a printer, or the like may be used as an output interface. As the communication interface 5, a LAN card, a modem, a router, or the like for connecting to the Internet or a LAN may be used.

An impact-ionization-current calculation program 6a for calculating an impact ionization current Iii of the field-effect transistor is installed in the external storage device 6. A drain transverse electric field setting function 6b is built in the impact-ionization-current calculation program 6a. In the drain transverse electric field setting function 6b, a saturated source-drain voltage V_{dsat} used for calculating a drain transverse electric field E_{d} is given by a function of a source-gate voltage V_{gs} and a source-drain voltage V_{ds}. Furthermore, the drain transverse electric field setting function 6b gives a characteristic length λ of the drain transverse electric field by the function of the source-gate voltage V_{gs} and the source-drain voltage V_{ds}.

More specifically, assuming that G(V_{gs}, V_{ds}), F(V_{gs}, V_{ds}), λ1 (V_{gs}, V_{ds}), and λ2 (V_{gs}, V_{ds}) are functions of V_{gs} and V_{ds}, the impact ionization current Iii can be given by the following equation. In the following Equation (2), α and β are fitting parameters.

$$Iii = α {E}_{1} exp ( - \frac{β}{{E}_{2}} ) Ids \\ {E}_{1} = \frac{\{ {V}_{ds} - G ( {V}_{gs} , {V}_{ds} ) \}}{{λ}_{1} ( {V}_{gs} , {V}_{ds} )} \\ {E}_{2} = \frac{\{ {V}_{ds} - F ( {V}_{gs} , {V}_{ds} ) \}}{{λ}_{2} ( {V}_{gs} , {V}_{ds} )} \qquad ( 2 )$$

In some embodiments, G(V_{gs}, V_{ds}) may be similar to F(V_{gs}, V_{ds}). However, in other embodiments, G(V_{gs}, V_{ds}) and F(V_{gs}, V_{ds}) may also be different functions in order to allow flexibility in fitting. Furthermore, in order to reproduce complex change in the drain transverse electric field E_{d} in a region with a low source-drain voltage V_{ds} or in a region with a high source-gate voltage V_{gs}, G(V_{gs}, V_{ds}) and F(V_{gs}, V_{ds}) are given as functions that use both the source-gate voltage V_{gs} and the source-drain voltage V_{ds} as parameters instead of being functions of only the source-gate voltage V_{gs} as in the initial formulation represented by Equation (1).

When the impact-ionization-current calculation program 6a is executed by the processor 1, the impact ionization current Iii is calculated according to the above Equation, and is provided to a person via the human interface 4.

The impact-ionization-current calculation program 6a to be executed by the processor 1 may be stored in the external storage device 6 so as to be loaded onto the RAM 3 when the program is executed. Furthermore, the impact-ionization-current calculation program 6a may be stored in the ROM 2 in advance, or may be acquired via the communication interface 5.

The saturated source-drain voltage V_{dsat} of the field-effect transistor gradually increases with increase in the source-gate voltage V_{gs}, and approaches a constant in a region in which V_{gs}−Vₜₕ>V_{ds}. Here, Vₜₕ is a threshold voltage of the field-effect transistor.

Therefore, when the saturated source-drain voltage V_{dsat} used for calculating the drain transverse electric field E_{d} is given by the function of the source-gate voltage V_{gs} and the source-drain voltage V_{ds}, it is possible to prevent the drain transverse electric field E_{d} from extremely decreasing even when the source-gate voltage V_{gs} increases while the source-drain voltage remains low.

As a result, when the gate length of the transistor is extremely reduced to be 0.1 μm or smaller, and if the source-gate voltage V_{gs} increases, it is possible to handle a phenomenon in which the impact ionization current Iii monotonously increases without decreasing. Therefore, it is possible to accurately reproduce the impact ionization current Iii in a wide range in accordance with various combinations of the source-gate voltage V_{gs} and the source-drain voltage V_{ds}.

From the viewpoint of correcting underestimation of the drain transverse electric field E_{d} in a region with a high source-gate voltage V_{gs} due to the initial formulation represented by Equation (1) described above, it is desirable that G(V_{gs}, V_{ds}) and F(V_{gs}, V_{ds}) are given by the following Equations (3) and (4), respectively.

G(V_{gs},V_{ds})=ξV_{dsat}−g(V_{gs},V_{ds}) (3)

F(V_{gs},V_{ds})=ηV_{dsat}−f(V_{gs},V_{ds}) (4)

Here, ξ and η are fitting parameters. Both f(V_{gs}, V_{ds}) and g(V_{gs}, V_{ds}) are given as functions that monotonously increase with respect to V_{gs}, and monotonously decrease with respect to V_{ds}. By adjusting the function forms and parameters of the functions depending on the situation, it is possible to accurately reproduce the impact ionization current Iii in a required arbitrary range.

To make the adjustment of the parameters easy, it is desirable to use polynomials represented by the following Equations (5) and (6) for example as f(V_{gs}, V_{ds}) and g(V_{gs}, V_{ds}), respectively, and to set λ₁(V_{gs}, V_{ds}) and λ₂(V_{gs}, V_{ds}) to be constants.

$$\begin{matrix}g ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix} & ( 5 ) \\ f ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix} & ( 6 ) \\ \frac{α}{{λ}_{1} ( {V}_{gs} , {V}_{ds} )} = A \text{:} constant number & \\ {βλ}_{2} ( {V}_{gs} , {V}_{ds} ) = B \text{:} constant number & \end{matrix}$$

By setting the above-described functions as impact ionization current formulas in a transistor model for circuit simulation or in a circuit reliability simulation device, the impact ionization current that allows for accurate reproduction of measured values can be calculated by circuit simulation. As a result, it is possible to accurately estimate the degradation of driving force of the transistor due to the hot carrier.

### Second Embodiment

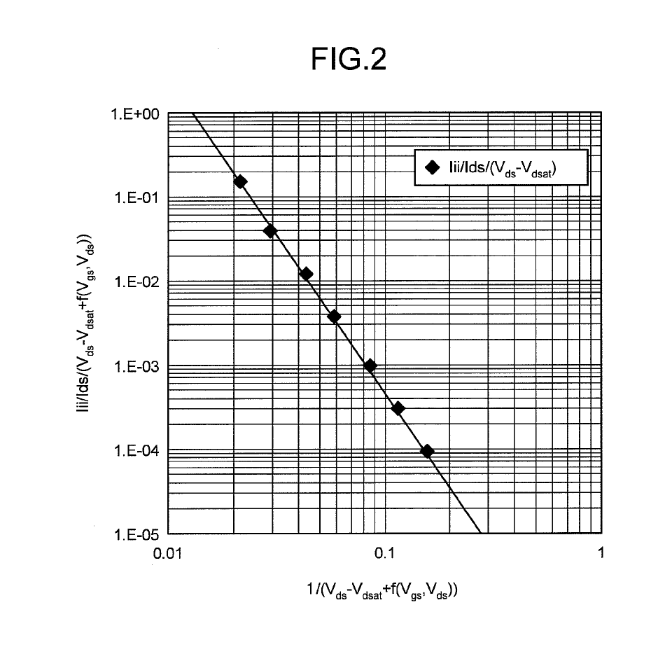

FIG. 2 is a diagram illustrating a method of adjusting fitting parameters of a function used for calculating an impact ionization current according to a second embodiment. In the example shown in FIG. 2, a logarithmic plot of Iii/[Ids×{(V_{ds}−Vdₛₐₜ)+f(V_{gs}, V_{ds})}] versus 1/{(V_{ds}−V_{dsat})+f(V_{gs}, V_{ds})} is illustrated.

In FIG. 2, Equation (5) and Equation (6) are represented by a third-order polynomial as represented by the following Equation (7) in order to make the calculation easy.

$$\begin{matrix}f ( {V}_{gs} , {V}_{ds} ) = g ( {V}_{gs} , {V}_{ds} ) \\ = \{ \begin{matrix}0 & ( {V}_{gs} - a {V}_{ds} + b < 0 ) \\ {\sum }_{n = 0}^{3} {{c}_{n} ( {V}_{gs} - a {V}_{ds} + b )}^{n} & ( {V}_{gs} - a {V}_{ds} + b \geq 0 )\end{matrix}\end{matrix} \qquad ( 7 )$$

Here, a (a≧0), b (b≧0), and cₙ (cₙ≧0) are fitting parameters.

By using the above polynomial, the fitting parameters a, b, c1, c2, c3, and B can be adjusted so that Iii/[Ids×{(V_{ds}−V_{dsat})+f(V_{gs}, V_{ds})}] versus 1/{(V_{ds}−V_{dsat})+f(V_{gs}, V_{ds})} becomes an approximate line.

For example, as shown in FIG. 2, when the parameters are set such that ξ=1, η=1, a=1.5, b=2.7, c1=0.04, c2=0.01, c3=0.008, and B=17, Iii/[Ids×{(V_{ds}−V_{dsat})+f(V_{gs}, V_{ds})}] versus 1/{(V_{ds}−V_{dsat})+f(V_{gs}, V_{ds})} can become an approximate line.

As the drain current Ids and the impact ionization current Iii, measured values can be used. It is allowed to obtain the drain current Ids by simulation by which measured values can be reproduced. In this case, the drain current Ids is obtained over regions of a desired source gate voltage V_{g}, and a desired source-drain voltage V_{ds} with which the impact ionization current is reproduced.

Subsequently, to reproduce the impact ionization current Iii by using the fitting parameters a, b, c1, c2, c3, and B, the impact ionization current Iii versus the source-gate voltage V_{gs} is plotted with respect to each source-drain voltage V_{ds}, and then measured values and calculated values are superimposed on each other.

Then, the fitting parameter A for the whole model is adjusted. For example, when the fitting parameter A is adjusted so that the measured value and the model calculated value of the impact ionization current Iii (A/μm) at the time V_{gs}=2.0 V and V_{ds}=2.7 V become equal to each other, A=0.0732.

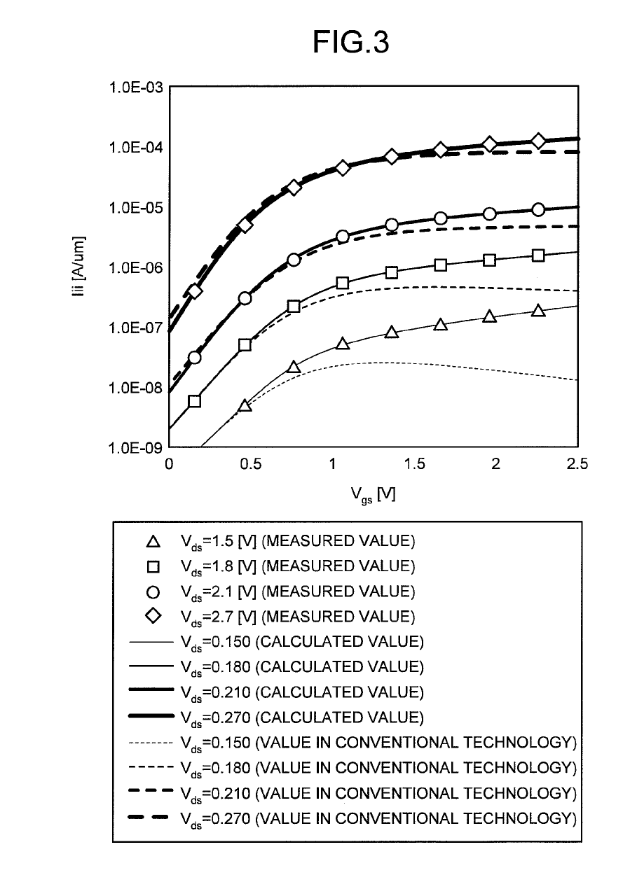

FIG. 3 is a diagram illustrating a relationship between the impact ionization current Iii, which is calculated by the circuit simulator shown in FIG. 1 by using the source-drain voltage V_{ds} as a parameter, and the source-gate voltage V_{gs}, with comparison to measured values.

In FIG. 3, in the embodiment of the present invention, the calculated values of the impact ionization current Iii in the region where V_{gs} is relatively high and V_{ds} is relatively low are accurately reproduced.

In contrast, when the impact ionization current Iii is calculated by Equation (1), the impact ionization current Iii gradually declines with respect to the measured values in the region where the source-gate voltage V_{gs} is high.

### Third Embodiment

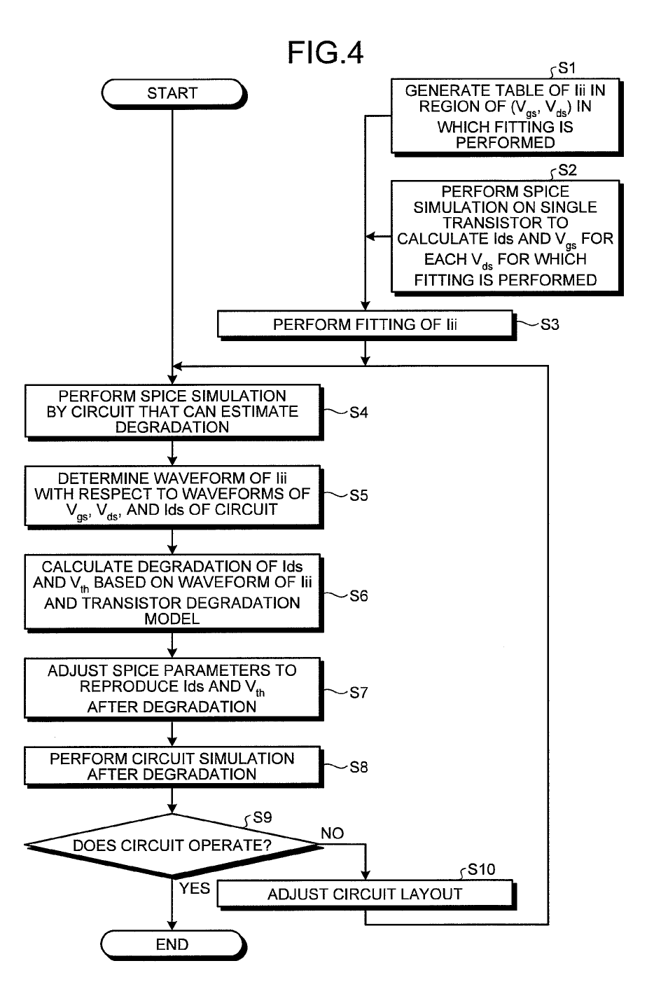

FIG. 4 is a flowchart for explaining a circuit design method according to a third embodiment.

In FIG. 4, a table of the impact ionization current Iii in the region of (V_{gs}, V_{ds}) in which the fitting is performed is generated (Step S1). The SPICE simulation is performed on a single transistor to thereby calculate the relationship between the drain current Ids and the source-gate voltage V_{gs} with respect to each source-drain voltage V_{ds} for which fitting is performed (Step S2). The fitting of the impact ionization current Iii is performed based on the results obtained at Steps S1 and S2 (Step S3).

The SPICE simulation is performed by a circuit that can estimate degradation, so that waveforms of the source-gate voltage V_{gs}, the source-drain voltage V_{ds}, and the drain current Ids are obtained (Step S4).

A waveform of the impact ionization current Iii is determined with respect to the waveforms of the source-gate voltage V_{gs}, the source-drain voltage V_{ds}, and the drain current Ids (Step S5).

The degradation of the drain current Ids and the threshold voltage Vₜₕ is calculated based on the waveform of the impact ionization current Iii and the transistor degradation model (Step S6).

The SPICE parameters are adjusted so that the degraded drain current Ids and the degraded threshold voltage Vₜₕ can be reproduced (Step S7).

The circuit simulation after the calculation of the degradation is performed, and, when the circuit does not operate, the circuit layout is adjusted (Steps S8 to S10). Then, the processes at Steps S4 to S10 are repeated until the circuit operates at Step S9.

Consequently, even when the field-effect transistors constituting semiconductor integrated circuits are miniaturized, it is possible to accurately estimate the degradation of the driving force of the field-effect transistor due to the hot carrier. As a result, it is possible to carry out appropriate designing with the degradation due to the hot carrier taken into account.

### Fourth Embodiment and Fifth Embodiment

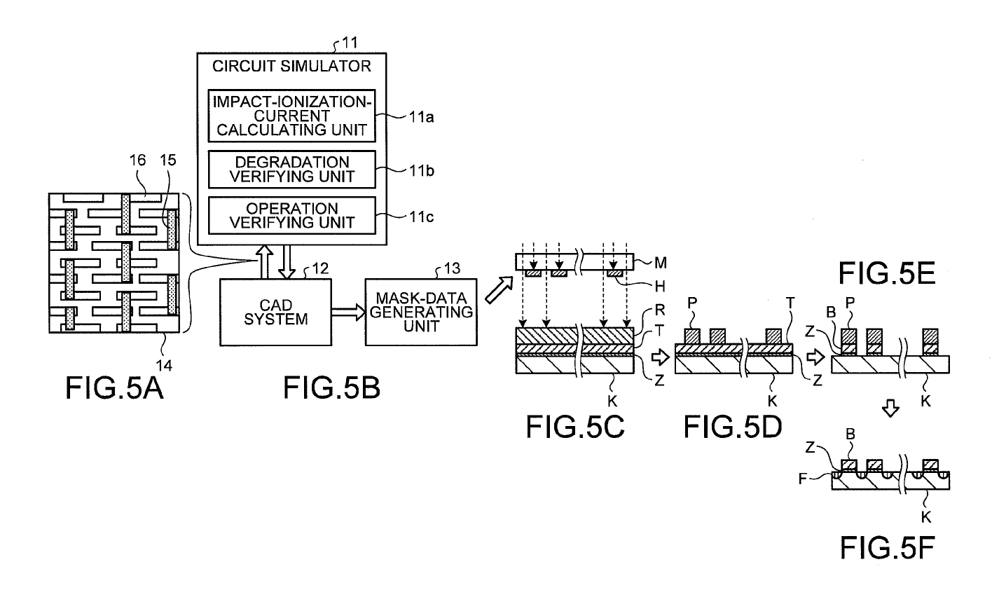

FIG. 5A is a diagram illustrating an example of design layout data; FIG. 5B is a block diagram illustrating a general configuration of a circuit simulator according to a fourth embodiment; FIGS. 5C-5F are diagrams explaining a method of manufacturing a semiconductor device according to a fifth embodiment.

In FIG. 5B, a circuit simulator 11 includes an impact-ionization-current calculating unit 11a that calculates the impact ionization current Iii according to the impact-ionization-current calculation program 6a shown in FIG. 1. The circuit simulator 11 can include a degradation verifying unit 11b that verifies the degradation of the field-effect transistor based on the impact ionization current Iii, or an operation verifying unit 11c that verifies whether the field-effect transistor normally operates.

Design layout data 14 of a semiconductor integrated circuit is generated in a CAD system 12, and sent to the circuit simulator 11. The design layout data 14 is able to specify a layout of an active region pattern 16, a gate electrode pattern 15, or the like of the semiconductor integrated circuit. Then, the impact-ionization-current calculating unit 11a calculates the impact ionization current Iii of the field-effect transistor specified by the design layout data 14.

The degradation verifying unit 11b verifies the degradation of the field-effect transistor based on the impact ionization current Iii calculated by the impact-ionization-current calculating unit 11a. Furthermore, the operation verifying unit 11c verifies whether the field-effect transistor normally operates after the field-effect transistor has degraded.

When the field-effect transistor does not normally operate after the field-effect transistor has degraded, the CAD system 12 adjusts the design layout data 14 so that the field-effect transistor normally operates after the field-effect transistor has degraded.

Then, a mask-data generating unit 13 generates mask data corresponding to the layout pattern specified by the adjusted design layout data 14. Accordingly, in FIG. 5C, a mask pattern specified by the mask data generated by the mask-data generating unit 13 is formed on a photo mask M with a light-shielding film H.

Furthermore, a polycrystalline silicon layer T is formed on a semiconductor substrate K via a gate insulating film Z. The polycrystalline silicon layer T is coated with a resist film R. Subsequently, the resist film R is exposed via the photo mask M and then developed, so that a resist pattern P is formed on the polycrystalline silicon layer T in FIG. 5D.

Then, in FIG. 5E, the polycrystalline silicon layer T is etched by using the resist pattern P as a mask, so that a gate electrode B corresponding to the gate electrode pattern 15 specified by the adjusted design layout data 14 is formed on the semiconductor substrate K. Then, in FIG. 5F, the resist pattern P is removed from the gate electrode B by a method such as ashing, and impurity is injected into the semiconductor substrate K by using the gate electrode B as a mask, so that an impurity diffused layer F is formed, forming a field-effect transistor on the semiconductor substrate K.

Because the degradation of the field-effect transistor is verified based on the impact ionization current Iii, and the design layout data 14 is adjusted so that the field-effect transistor normally operates after the field-effect transistor has degraded, it is possible to improve the reliability of the filed-effect transistor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A circuit simulator comprising:
a processor configured to calculate an impact ionization current of a field-effect transistor based on a calculation of a drain transverse electric field, the calculation using a saturated source-drain voltage, a source-gate voltage, and a source-drain voltage.

2. The circuit simulator of claim 1, wherein the processor is configured to calculate a value for the impact ionization current (Iᵢᵢ) that satisfies the following equation:
$${I}_{ii} = α {E}_{1} exp ( - \frac{β}{{E}_{2}} ) {I}_{ds} ,$$
wherein E₁ and E₂ satisfy the following equations:
$${E}_{1} = \frac{\{ {V}_{ds} - G ( {V}_{gs} , {V}_{ds} ) \}}{{λ}_{1} ( {V}_{gs} , {V}_{ds} )}$$
$${E}_{2} = \frac{\{ {V}_{ds} - F ( {V}_{gs} , {V}_{ds} ) \}}{{λ}_{2} ( {V}_{gs} , {V}_{ds} )}$$
wherein α and β are fitting parameters, I_{ds} is a drain current of the field-effect transistor, V_{gs} is the source-gate voltage, V_{ds} is the source-drain voltage, and G(V_{gs}, V_{ds}), F(V_{gs}, V_{ds}) λ₁(V_{gs}, V_{ds}) and λ₂(V_{gs}, V_{ds}) are functions of V_{gs} and V_{ds}.

3. The circuit simulator of claim 2, wherein
the function G(V_{gs}, V_{ds}) and the function F(V_{gs}, V_{ds}) satisfy following equations:
G(V_{gs},V_{ds})=ξV_{dsat}−g(V_{gs},V_{ds})
F(V_{gs},V_{ds})=ηV_{dsat}−f(V_{gs},V_{ds})
wherein V_{dsat} is the saturated source-drain voltage, ξ and η are fitting parameters, and g(V_{gs}, V_{ds}) and f(V_{gs}, V_{ds}) are functions of V_{gs} and V_{ds}.

4. The circuit simulator of claim 3, wherein the function g(V_{gs}, V_{ds}) and the function f(V_{gs}, V_{ds}) monotonously increase with respect to V_{gs}, and monotonously decrease with respect to V_{ds}.

5. The circuit simulator of claim 4, wherein
the function g(V_{gs}, V_{ds}) and the function f(V_{gs}, V_{ds}) satisfy the following equations:
$$\begin{matrix}g ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix} \\ f ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix}\end{matrix}$$
wherein a (a≧0), b (b≧0), and cₙ (cₙ≧0) are fitting parameters.

6. The circuit simulator of claim 5, wherein
the function g(V_{gs}, V_{ds}) and the function f(V_{gs}, V_{ds}) satisfy following equations:
$$\begin{matrix}f ( {V}_{gs} , {V}_{ds} ) = g ( {V}_{gs} , {V}_{ds} ) \\ = \{ \begin{matrix}0 & ( {V}_{gs} - a {V}_{ds} + b < 0 ) \\ {\sum }_{n = 0}^{3} {{c}_{n} ( {V}_{gs} - a {V}_{ds} + b )}^{n} & ( {V}_{gs} - a {V}_{ds} + b \geq 0 )\end{matrix}\end{matrix}$$
$$\frac{α}{{λ}_{1} ( {V}_{gs} , {V}_{ds} )} = A$$
$${βλ}_{2} ( {V}_{gs} , {V}_{ds} ) = B$$
wherein A and B are fitting parameters.

7. The circuit simulator of claim 6, wherein
the fitting parameters are set so that the value of Iii/[Ids×{(V_{ds}−V_{dsat})+f(V_{gs}, V_{ds})}] versus the value of 1/{(V_{ds}−V_{dsat})+f(V_{gs}, V_{ds})}, when plotted on a graph, lies approximately along a line.

8. A circuit simulator comprising:
a processor and memory in communication with the processor storing a computer program, the computer program comprising:
an impact-ionization-current calculating module configured to calculate an impact ionization current of a field-effect transistor based on a calculation of a drain transverse electric field, the calculation using a saturated source-drain voltage, a source-gate voltage, and a source-drain voltage;
a degradation verifying module configured to verify degradation of a characteristic of the field-effect transistor based on the impact ionization current calculated by the impact-ionization-current calculating module; and
an operation verifying module configured to verify whether the field-effect transistor normally operates after degradation of the field-effect transistor.

9. The circuit simulator of claim 8, wherein
the impact-ionization-current calculating module is configured to calculate a value for the impact ionization current (Iii) that satisfies the following equation:
$$Iii = α {E}_{1} exp ( - \frac{β}{{E}_{2}} ) Ids ,$$
wherein E₁ and E₂ satisfy the following equations:
$${E}_{1} = \frac{\{ {V}_{ds} - G ( {V}_{gs} , {V}_{ds} ) \}}{{λ}_{1} ( {V}_{gs} , {V}_{ds} )}$$
$${E}_{2} = \frac{\{ {V}_{ds} - F ( {V}_{gs} , {V}_{ds} ) \}}{{λ}_{2} ( {V}_{gs} , {V}_{ds} )}$$
wherein α and β are fitting parameters, I_{ds} is a drain current of the field-effect transistor, V_{gs} is the source-gate voltage, V_{ds} is the source-drain voltage, and G(V_{gs}, V_{ds}), F(V_{gs}, V_{ds}), λ₁(V_{gs}, V_{ds}) and λ₂(V_{gs}, V_{ds}) are functions of V_{gs} and V_{ds}.

10. The circuit simulator of claim 9, wherein
the function G(V_{gs}, V_{ds}) and the function F(V_{gs}, V_{ds}) satisfy the following equations:
G(V_{gs},V_{ds})=ξV_{dsat}−g(V_{gs},V_{ds})
F(V_{gs},V_{ds})=ηV_{dsat}−f(V_{gs},V_{ds})
wherein V_{dsat} is the saturated source-drain voltage, ξ and η are fitting parameters, and g(V_{gs}, V_{ds}) and f(V_{gs}, V_{ds}) are functions of V_{gs} and V_{ds}.

11. The circuit simulator of claim 10, wherein the function g(V_{gs}, V_{ds}) and the function f(V_{gs}, V_{ds}) monotonously increase with respect to V_{gs}, and monotonously decrease with respect to V_{ds}.

12. The circuit simulator of claim 11, wherein
the function g(V_{gs}, V_{ds}) and the function f(V_{gs}, V_{ds}) satisfy the following equations:
$$\begin{matrix}g ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix} \\ f ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix}\end{matrix}$$
wherein a (a≧0), b (b≧0), and cₙ (cₙ≧0) are fitting parameters.

13. The circuit simulator of claim 12, wherein
the function g(V_{gs}, V_{ds}) and the function f(V_{gs}, V_{ds}) satisfy following equations:
$$\begin{matrix}f ( {V}_{gs} , {V}_{ds} ) = g ( {V}_{gs} , {V}_{ds} ) \\ = \{ \begin{matrix}0 & ( {V}_{gs} - a {V}_{ds} + b < 0 ) \\ {\sum }_{n = 0}^{3} {{c}_{n} ( {V}_{gs} - a {V}_{ds} + b )}^{n} & ( {V}_{gs} - a {V}_{ds} + b \geq 0 )\end{matrix}\end{matrix}$$
$$\frac{α}{{λ}_{1} ( {V}_{gs} , {V}_{ds} )} = A$$
$${βλ}_{2} ( {V}_{gs} , {V}_{ds} ) = B$$
where A and B are fitting parameters.

14. A method of designing a semiconductor device comprising:
calculating an impact ionization current of a field effect transistor based on a calculation of a drain transverse electric field, the calculation using a saturated source-drain voltage, a source-gate voltage, and a source-drain voltage; and
adjusting a layout in the semiconductor device of the field effect transistor based on a result obtained from the calculating of the impact ionization.

15. The method of claim 14, further comprising:
calculating a degradation of a characteristic of the field-effect transistor based on the result obtained from the calculating of the impact ionization; and
adjusting the layout of the field-effect transistor when the degradation of the characteristic of the field-effect transistor results in abnormal operation of the field-effect transistor.

16. The method of claim 14, wherein the method comprises calculating a value for the impact ionization current (Iᵢᵢ) that satisfies the following equation:
$$Iii = α {E}_{1} exp ( - \frac{β}{{E}_{2}} ) {I}_{ds}$$
$${E}_{1} = \frac{\{ {V}_{ds} - G ( {V}_{gs} , {V}_{ds} ) \}}{{λ}_{1} ( {V}_{gs} , {V}_{ds} )} ,$$
wherein E₁ and E₂ satisfy the following equations:
$${E}_{2} = \frac{\{ {V}_{ds} - F ( {V}_{gs} , {V}_{ds} ) \}}{{λ}_{2} ( {V}_{gs} , {V}_{ds} )}$$
wherein α and β are fitting parameters, I_{ds} is a drain current of the field-effect transistor, V_{gs} is the source-gate voltage, V_{ds} is the source-drain voltage, and G(V_{gs}, V_{ds}), F(V_{gs}, V_{ds}), λ₁(V_{gs}, Vds), and λ₂(V_{gs}, V_{ds}) are functions of V_{gs} and V_{ds}.

17. The method of claim 16, wherein
the function G(V_{gs}, V_{ds}) and the function F(V_{gs}, V_{ds}) satisfy the following equations:
G(V_{gs},V_{ds})=ξV_{dsat}−g(V_{gs},V_{ds})
F(V_{gs},V_{ds})=ηV_{dsat}−f(V_{gs},V_{ds})
wherein V_{dsat} is the saturated source-drain voltage, ξ and η are fitting parameters, and g(V_{gs}, V_{ds}) and f(V_{gs}, V_{ds}) are functions of V_{gs} and V_{ds}.

18. The method of claim 17, wherein
the function g(V_{gs}, V_{ds}) and the function f(V_{gs}, V_{ds}) satisfy the following equations:
$$\begin{matrix}g ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix} \\ f ( {V}_{gs} , {V}_{ds} ) = \{ \begin{matrix}0 & ( {V}_{gs} - a {V}_{ds} + b < 0 ) \\ {\sum }_{n = 0}^{N} {{c}_{n} ( {V}_{gs} - a {V}_{ds} + b )}^{n} & ( {V}_{gs} - a {V}_{ds} + b \geq 0 ) \\ a > 0 , b > 0 , {c}_{n} > 0 & \end{matrix}\end{matrix}$$
wherein a (a≧0), b (b≧0), and cₙ (cₙ≧0) are fitting parameters.

19. The method of claim 18, wherein
the function g(V_{gs}, V_{ds}) and the function f(V_{gs}, V_{ds}) satisfy following equations:
$$\begin{matrix}f ( {V}_{gs} , {V}_{ds} ) = g ( {V}_{gs} , {V}_{ds} ) \\ = \{ \begin{matrix}0 & ( {V}_{gs} - a {V}_{ds} + b < 0 ) \\ {\sum }_{n = 0}^{3} {{c}_{n} ( {V}_{gs} - a {V}_{ds} + b )}^{n} & ( {V}_{gs} - a {V}_{ds} + b \geq 0 )\end{matrix}\end{matrix}$$
$$\frac{α}{{λ}_{1} ( {V}_{gs} , {V}_{ds} )} = A$$
$${βλ}_{2} ( {V}_{gs} , {V}_{ds} ) = B$$
wherein A and B are fitting parameters.

20. The method of claim 19, wherein
the fitting parameters are set so that the value of Iᵢᵢ/[I_{ds}×{(V_{ds}−V_{dsat})+f(V_{gs}, Vₐₛ)}] versus the value of 1/{(V_{ds}−V_{dsat})+f(V_{gs}, V_{ds})}, when plotted on a graph, lies approximately along a line.
